(19) United States
(12) Patent Application Publication
(10) Pub. No.: US 2017/0099582 A1
(43) Pub. Date: Apr. 6, 2017

(54) Method for the Automatic Classification of Trips

(71) Applicant: Lars Boesen, Woodinville, WA (US)

(72) Inventor: Lars Boesen, Woodinville, WA (US)

(21) Appl. No.: 15/380,726

(22) Filed: Dec. 15, 2016

Related U.S. Application Data
(63) Continuation-in-part of application No. 14/932,523, filed on Nov. 4, 2015.
(60) Provisional application No. 62/268,206, filed on Dec. 16, 2015.
(60) Provisional application No. 62/076,021, filed on Nov. 6, 2014.

(51) Int. Cl. H04W 4/02; H04L 29/08

(52) U.S. Cl. CPC H04W 4/028; H04L 67/306; H04W 88/02

(57) ABSTRACT

A method for the identification of a person based on their past motion history and for the automatic classification of trips. The method of the present invention uses a sensor device such as a smartphone that a user/person is already carrying. Then, after traveling or reaching a specific location, the current motion data and past motion data are used to match one of several specific user profiles based on actions at the destinations and behavior prior to arrival to determine whether the person was a driver or passenger and the nature or classification of their trip.

### CROSS REFERENCE TO RELATED APPLICATIONS

This application claims priority from U.S. patent application Ser. No. 62/268,206, entitled “Method for the Automatic Classification of Trips”, filed on 16 Dec. 2015. The benefit under 35 USC §119(e) of the United States provisional application is hereby claimed, and the aforementioned application is hereby incorporated herein by reference.

This application claims priority from and is a continuation in part (CIP) of U.S. patent application Ser. No. 14/932,523, entitled “System and Method for the Automatic Persona Identification of a Person Post Motion”, filed on 04 Nov. 2015. The benefit under 35 USC §119(e) of the United States provisional application is hereby claimed, and the aforementioned application is hereby incorporated herein by reference.

U.S. patent application Ser. No. 14/932,523 application claims priority from and is a non-provisional of U.S. patent application Ser. No. 62/076,021, entitled “System and Method for the Automatic Persona Identification of a Person Post Motion”, filed on 06 Nov. 2014. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to the electronic tracking of “trips”. More specifically, the present invention relates to a means to automatically identifying and classifying an electronically tracked trip.

### BACKGROUND OF THE INVENTION

The prior art teaches where trips are driven by cars but not about who is driving the car or the purpose of the trip. The prior art bases their business model assuming anyone in the car is the driver and is not concerned about developing one or more trip classifications or automatically identifying a trip for classification for personal or business purposes.

Until now, an ODB-II device had to be connected to a car electric system and wirelessly to a smartphone to receive the motors signal that the phone is in the car proximity and that the engine was first started and then stopped. This defined an end of trip but not whether the smartphone owner was the driver or passenger and not whether the trip could be classified as personal, business, or any other sub-category of either.

A smartphone only solutions using motion sensor, GPS, satellite, or cell tower signal to track motion e.g. start and stop of a trip, such solutions hasn't differentiated between a person being a passenger or a driver—e.g. did a passenger get seen as a driver when they drove in car or why they are taking the trip.

Therefore, what is needed is a new system and method for collecting, recording, using, and transmitting present, past, and future motion data of a user that does not require the expense and complication of one or more sensors, but is used in combination with current technology, such as a smartphone, that many potential users of the data already have on their person.

### DEFINITIONS

An “accelerometer” is a device that measures proper acceleration (“g-force”). Proper acceleration is not the same as coordinate acceleration (rate of change of velocity).

The APPLE M7 (codename Oscar), M8, and M9 are motion coprocessors used by APPLE Inc. in their mobile devices. Their function is to collect sensor data from integrated accelerometers, gyroscopes and compasses and offload the collecting and processing of sensor data from the main central processing unit (CPU).

“Application software” or “software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become very popular and in 2010 was listed as “Word of the Year” by the American Dialect Society.

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

A compass is an instrument used for navigation and orientation that shows direction relative to the geographic cardinal directions, or “points”. Usually, a diagram called a compass rose, shows the directions north, south, east, and west as abbreviated initials marked on the compass.

“Electronic Mobile Device” is defined as any computer, phone, or computing device that is comprised of a battery, display, circuit board, and processor that is capable of processing or executing software. Examples of electronic mobile devices are smartphones, laptop computers, and table PCs.

The Global Positioning System (GPS) is a space-based navigation system that provides location and time information in all weather conditions, anywhere on or near the Earth where there is an unobstructed line of sight to four or more GPS satellites.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

A gyroscope (from Greek γ™\tilde{υ}ρoζ gûros, “circle” and σκoπ\acute{ε}ω skopéō, “to look”) is a spinning wheel or disc in which the axis of rotation is free to assume any orientation. When rotating, the orientation of this axis is unaffected by tilting or rotation of the mounting, according to the conservation of angular momentum. Because of this, gyroscopes are useful for measuring or maintaining orientation. Applications of gyroscopes include inertial navigation systems where magnetic compasses would not work (as in the Hubble telescope) or would not be precise enough (as in intercontinental ballistic missiles), or for the stabilization of flying vehicles like radio-controlled helicopters or unmanned aerial vehicles, and recreational boats and commercial ships.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “motion detector” is a device that detects moving objects, particularly people. A motion detector is often integrated as a component of a system that automatically performs a task or alerts a user of motion in an area. Motion detectors form a vital component of security, automated lighting control, home control, energy efficiency, and other useful systems. An electronic motion detector contains an optical, microwave, or acoustic sensor, and in many cases a transmitter for illumination. There are several motion detection technologies in wide use: Passive infrared (PIR); Microwave; Ultrasonic; Tomographic motion detector; and Video camera software.

“Persona” is the way a person behaves, talks, etc., with other people that causes others to see the person as a particular kind of person; the image or personality that a person presents to other people. In the present invention, “Persona” is focused on the role a person is playing such as a buyer or a seller, or a driver or a passenger in a vehicle. The present invention helps define a more accurate reputation system for e.g. drivers and passengers.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio(e.g. LTE), Wi-Fi, 3rd-party apps, motion sensor and mobile payment.

A “trip” is defined as the movement of a person from a starting point to an end point or destination. A trip may or may not include multiple stops of various lengths of time.

A “User” is any person registered to use the computer system executing the method of the present invention.

A “web application” or “web app” is any application software that runs in a web browser and is created in a browser-supported programming language (such as the combination of JavaScript, HTML and CSS) and relies on a web browser to render the application.

“Wi-Fi”, also spelled Wifi, WiFi, or wifi, is a local area wireless technology that allows an electronic device to exchange data or connect to the internet using 2.4 GHz UHF and 5 GHz SHF radio waves. The name is a trademark name, and is a play on the audiophile term Hi-Fi. The Wi-Fi Alliance defines Wi-Fi as any “wireless local area network (WLAN) products that are based on the Institute of Electrical and Electronics Engineers' (IEEE) 802.11 standards”.[1] However, since most modern WLANs are based on these standards, the term “Wi-Fi” is used in general English as a synonym for “WLAN”. Only Wi-Fi products that complete Wi-Fi Alliance interoperability certification testing successfully may use the “Wi-Fi CERTIFIED” trademark

### SUMMARY OF THE INVENTION

The present invention is a method for the identification of a person based on their past motion history and for the automatic classification of trips. The method of the present invention uses a sensor device such as a smartphone that a user/person is already carrying. Then, after traveling or reaching a specific location, the current motion data and past motion data are used to match one of several specific user profiles based on actions at the destinations and behavior prior to arrival to determine whether the person was a driver or passenger and the nature or classification of their trip. The method of the present invention teaches this using sensor data collected through a smartphone device itself and from radio signals collected by smartphone.

The present invention requires no ODB or beacon external connections to predict when a smartphone user is the driver or the passenger based on exit direction after arriving at a destination and validated by specific behavior in the vehicle/car. This outcome is improved over time using machine learning based on user edits or corrections of proposed status.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the method of the present invention for the automatic persona identification of a person post motion.

FIG. 2 is a sketch illustrating a first destination scenario of the present invention.

FIG. 3 is a sketch illustrating a second destination scenario of the present invention.

FIG. 4 is a flow chart illustrating the auto-classification rules of the present invention.

FIG. 5 illustrates how a rule is defined by the present invention for auto-classification.

FIG. 6 illustrates a list of exemplary rules of the present invention.

FIG. 7 illustrates the creation of a rule in the present invention using a GUI.

FIG. 8 illustrates the list of a GUI to enter typical destination locations such as home and workplaces or offices.

FIG. 9 illustrates the reporting and classification of a typical trip by the present invention.

FIG. 10 illustrates a reporting feature shown on a GUI listing a plurality of trips that have been auto-classified by the present invention with additional calculated information.

FIG. 11 is a GUI illustration of a typical automobile and related expense report calculated by the present invention.

FIGS. 12-13 are GUI illustrations of a user account where a user can enter specific and custom information about their life to better help the method automatically classify their trips.

FIG. 14 is a diagram of the auto-classify system taught by the present invention.

FIG. 15 is a visual representation of the auto classification rules taught by the present invention.

FIGS. 16-17 are flow charts illustrating the auto classification rules as taught by the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention is practiced. These embodiments are described in sufficient detail to enable those skilled in the art to practice the invention, but other embodiments is utilized and logical, mechanical, electrical, and other changes is made without departing from the scope of the present invention. The following detailed description is, therefore, not to be taken in a limiting sense, and the scope of the present invention is defined only by the appended claims.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

The present invention is a method for the identification of a person based on their past motion history. The method of the present invention uses a sensor device such as a smartphone that a user/person is already carrying. Then, after traveling or reaching a specific location, the current motion data and past motion data are used to match one of several specific user profiles based on actions at the destinations and behavior prior to arrival. For example, the collected data can be used to determine if the user/person was the driver or the passenger after a car trip or a shopper or pedestrian after watching a display window. The method of the present invention teaches this using sensor data collected through a smartphone device itself and from radio signals collected by smartphone.

The present invention requires no ODB or beacon external connections to predict when a smartphone user is the driver or the passenger, but bases this decision and assignment of persona on specific behavior in car. This outcome is improved over time using machine learning based on user edits of proposed status.

The solution of the present invention results in higher quality data from a single device solution at lower cost and simplicity. The present invention provides rapid deployment of scale with low support cost as only requirement is existing smartphone device and download of an app in an existing app store. No data plan is required. Accurate driver statistics across multiple transportation modes e.g. multiple cars, taxi, rental car, car sharing, motorcycle enabling more precise costing for both current (car insurance) and new business models such as usage based insurance and car sharing and builds a reputation model and score to be used to document driving proficiency for professional drivers, job applicants.

In one embodiment, to predict when a smartphone user is the driver or the passenger based on exit direction after arriving at a destination and validated by specific behavior in car such as charging, which predicts front row location and the main user of car; long use of cell phone while driving in high speed predicts a passenger; past travel patterns.

An example of this embodiment is when a person has previously acknowledged to have driven as driver e.g. 90% of the time to the same destination at e.g. 8 AM on Mondays, prior driving style from other trips identifying driver, such as similar acceleration after stops; and user behavior and profile by other app users in the same vehicle. Using these factors, the method can make a decision on whether to classify the user/person as a driver or passenger in the vehicle with a higher degree of certainty.

By measuring device use in combination with motion data it is possible to predict intense use of tapping related to email and text messaging by collecting a devices gyroscope. The present invention may also use the occurrence or case of recording gyroscope data over a longer period while a device is traveling at high speed (10-150 mph range) to predict passenger vs driver as one functional step of the method of the present invention.

The present invention correctly predicts a user status based on geo motion after a specific state or specific location—end location—has been reached. The method then profiles a person as “driver” or “passenger” based on the persons exit direction at end of trip defined as X+n meters, X and X−y meters where n is defined as distance after user has taken z steps walking, y is the angle in degrees measuring a user/person's exiting direction from a vehicle, and X is defined as location where vehicle has reached zero speed.

In the US, a 200 person questioner research performed by the inventors, showed 80% of people last time in the car were driving alone. 15% of the time they were a passenger in front seat and only 5% of people were in the back seat. Of these 5%, 80% exit through the right back door. Meaning 1% of will use left back door to exit and would with this invention report a False Positive as a driver. This implies the present invention can improve driver data collection from 80% accuracy to a +99% accuracy.

For certain segments, the young or females, research shows the data improvement appears to be even higher. The inventors will overcome the False Positive by using secondary indicators such as was phone charged while in motion, is the user predominantly driver in the past, time of day vs prior trips on the same route, etc.

The method of the present invention is embodied as a software application or App and uses a phones location services to identify a trip start and a trip end. In an IPHONE, the App uses APPLE's iOS CLLocationManager to initiate, record and complete trip. At the Start of a Trip 101, once the app is on and the location services are enabled, the App starts listening to the GPS and sensor data. Trip will start when speed exceeds predefined speed. and will continue to run until an end of trip or trip change is detected 102. A change in trip or end of trip is typically determined by a reduction in travel speed below 1 mile per hour for a predefined period 103. Once this occurs, the App. starts the end of trip method.

At the End of Trip, when the App detects that the speed is reduced below 1 mile per hour, the method of the present invention enables analysis of various motion sensor data input to conclude with certainty a trip has completed 104.

Once the motion manager is activated 105, the App, in an IPHONE embodiment, switches the location services to use CLLocationManager to start collect GPS data 105. Trips which are 1 minute apart get merged into one 113.

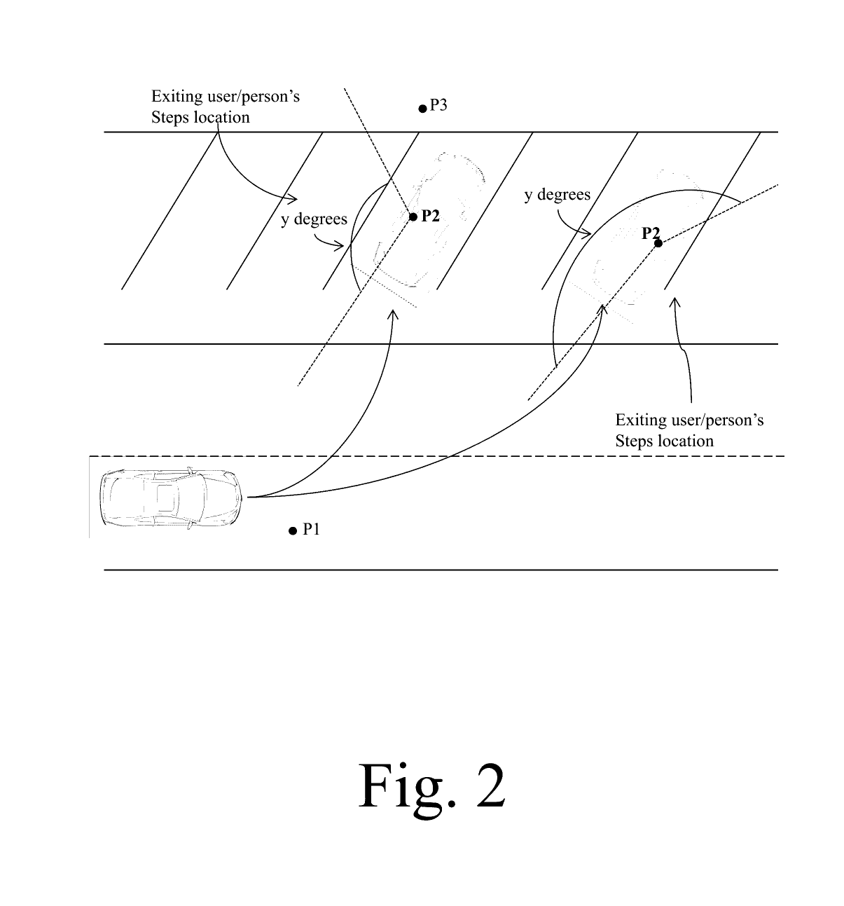

Now referring to FIG. 2, a first GPS point used is at a location at x meters before the end of a trip P1 106. A second point when speed reaches zero, P2 107. A third point P3 when a person has taken x steps after trip has terminated 108. The Trip end will happen if at least seven steps are recorded 109. A slope is calculated for P1 to P2 and P2 to P3 110. An Angle is calculated between these two slopes 111. The user/person's exit is right if the angle is greater than 180 degrees and left if less than 180 degrees as shown in the FIG. 2 112.

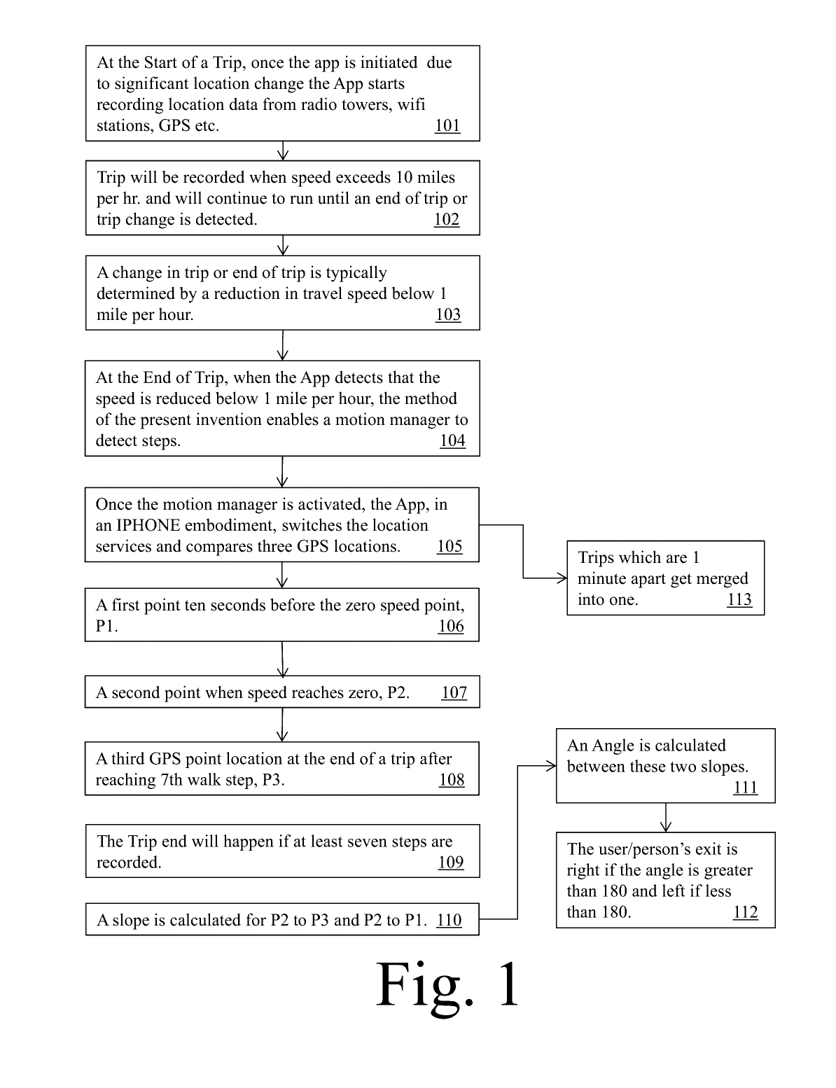

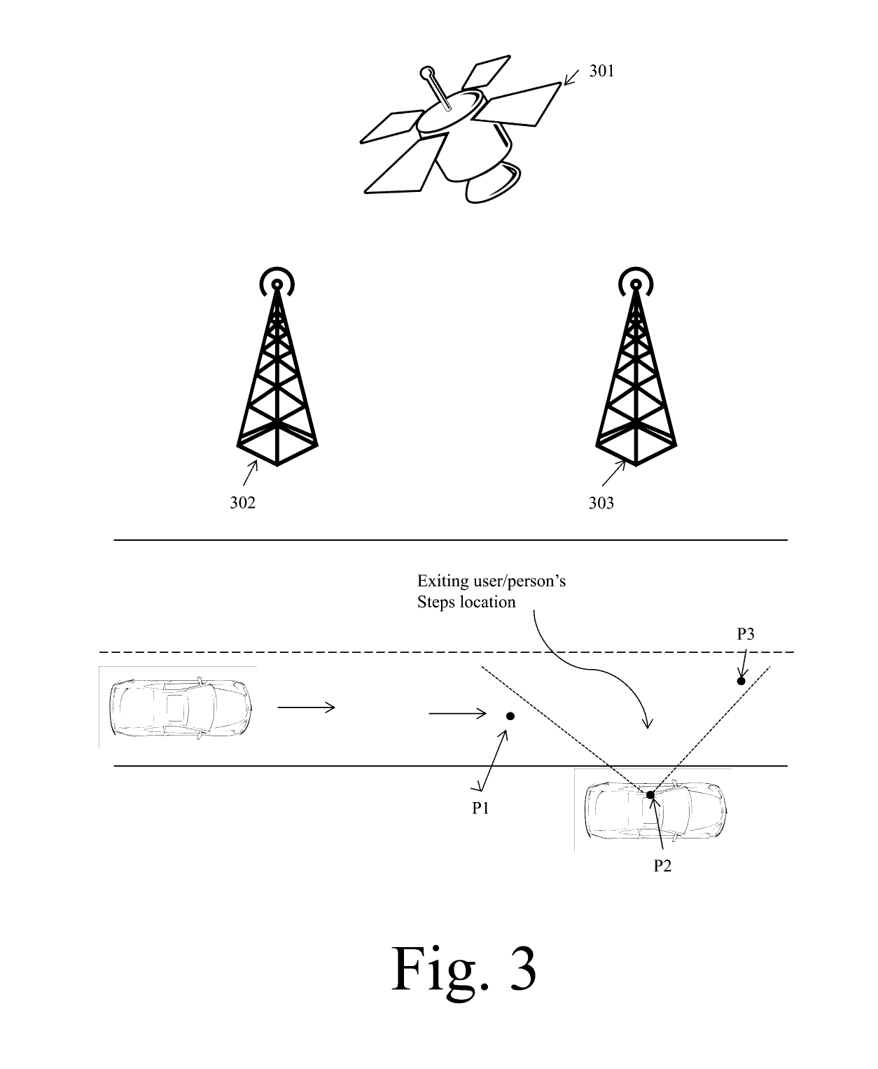

FIG. 3 is a sketch illustrating a second destination scenario of the present invention. In this scenario, location points and GPS data are provided by satellites 301 or triangulation by two or more cell towers 302 and 303. The process is the same as shown in FIGS. 1 and 2 with respect to the determination of the end of a trip P1, a second point when speed reaches zero P2, and a third point P3 when a person has taken x steps after the trip has terminated. A slope is calculated for P1 to P2 and P2 to P3. An Angle is calculated between these two slopes. The user/person's exit is right if the angle is greater than 180 degrees and left if less than 180 degrees as shown in FIG. 3.

In another embodiment, the classification of a trip for an identified person can be determined. The two methods can be used individually or in combination so that a user can be identified as a driver or passenger and the trip can also be automatically classified, but it is not required that the user be identified as a driver for auto classification of a trip and it is also not required that any trip resulting in an identified person be classified.

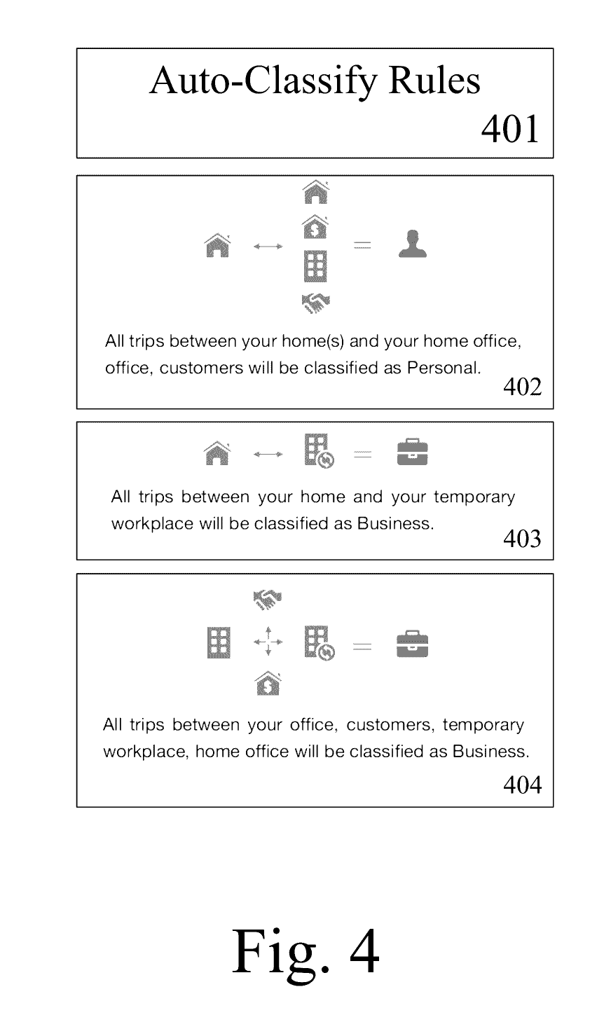

FIG. 4 is a flow chart illustrating the auto-classification rules 400 of the present invention. All trips between a user's home and their office or a customer's location will classified as “Personal” 401. All trips between a user's home and any temporary workplace will be classified as “business” 402. All trips between a user's office, customers, temporary workplace, and any home office would be classified as “business” 403.

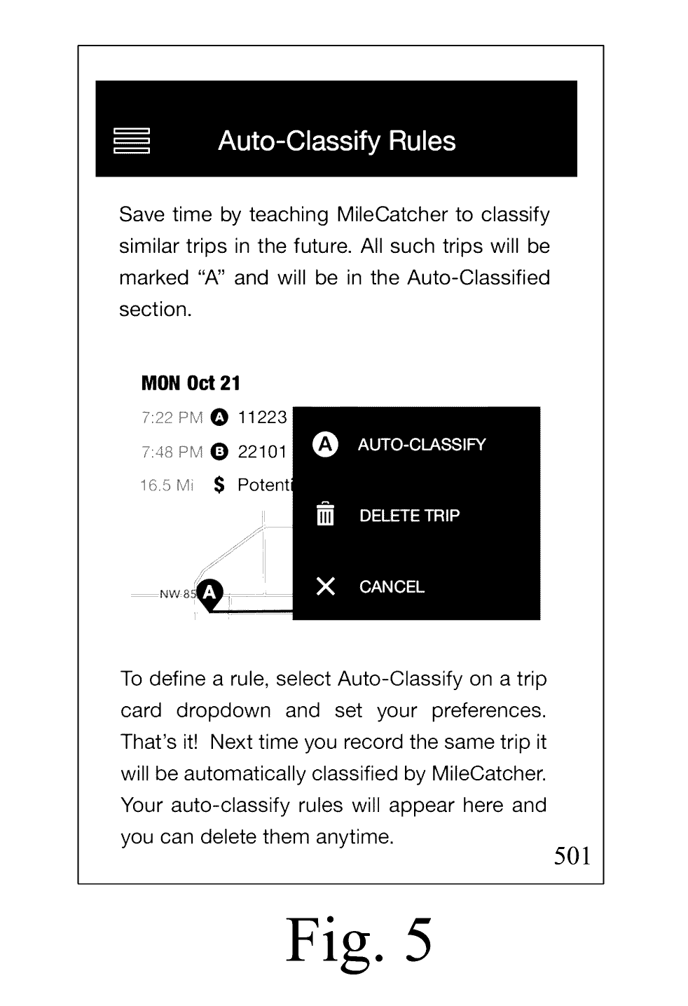

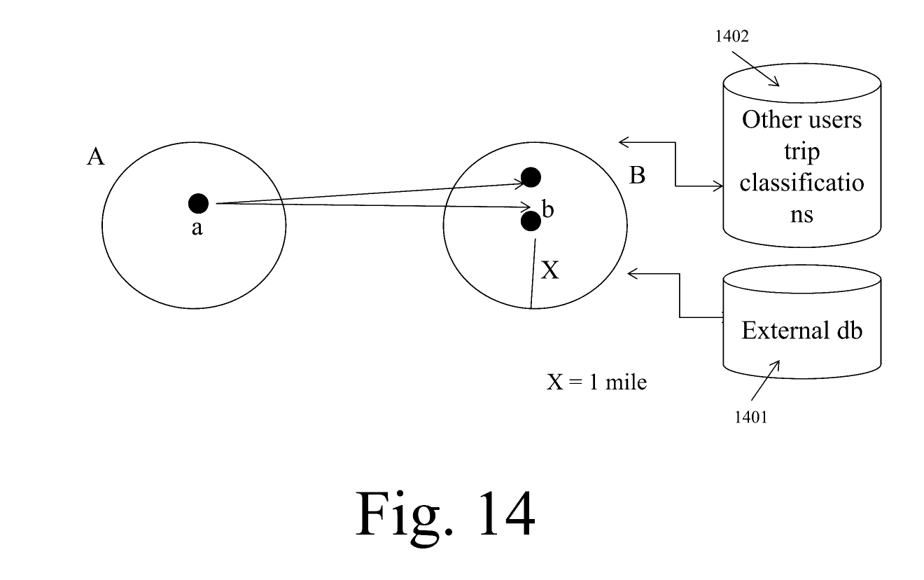

FIG. 5 illustrates how a rule is defined by the present invention for auto-classification. The method of the present invention can classify similar trips in the future based off of past history 501. For this to occur, one must define a rule as part of the process by selecting auto-classify on a trip card dropdown and setting a preference in a user account. Once that is done, the next time the user records the same trip it will automatically be classified by the method of the present invention. The system will develop a set of one or more user defined rules and will continually apply them. This set of rules is shown and explained in FIGS. 14-17.

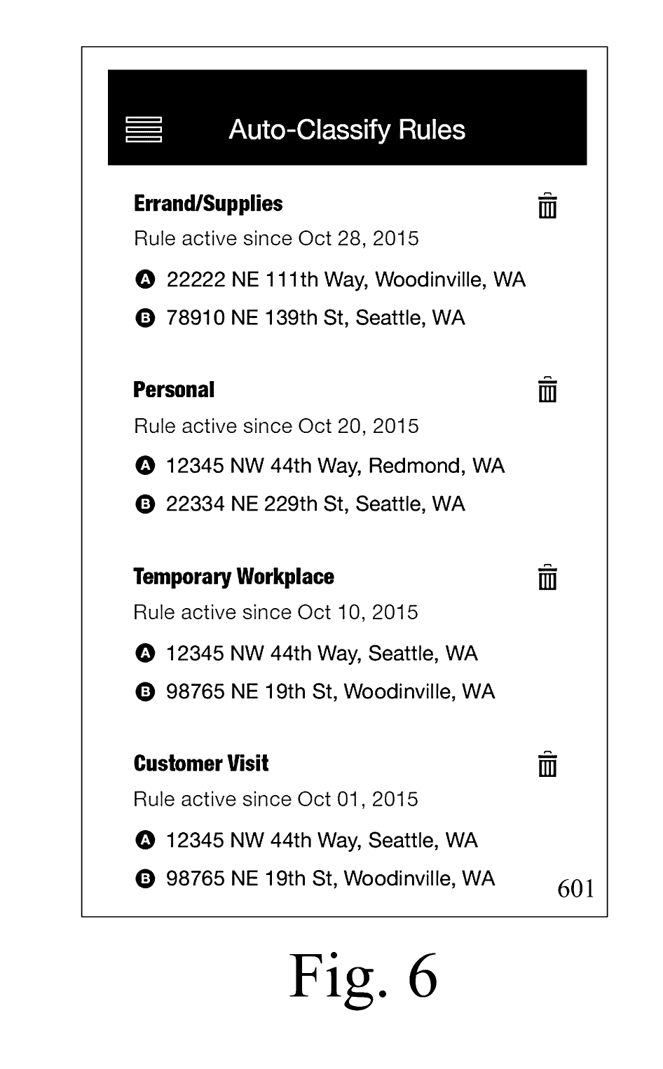

FIG. 6 illustrates a list of exemplary rules developed by a user 601. In this situation, the user has set rules for various trips from a plurality of starting points, “A” and a plurality of destination or ending points, “B” and has fixed them with an automatic classification and labeled them as well as customer or work locations.

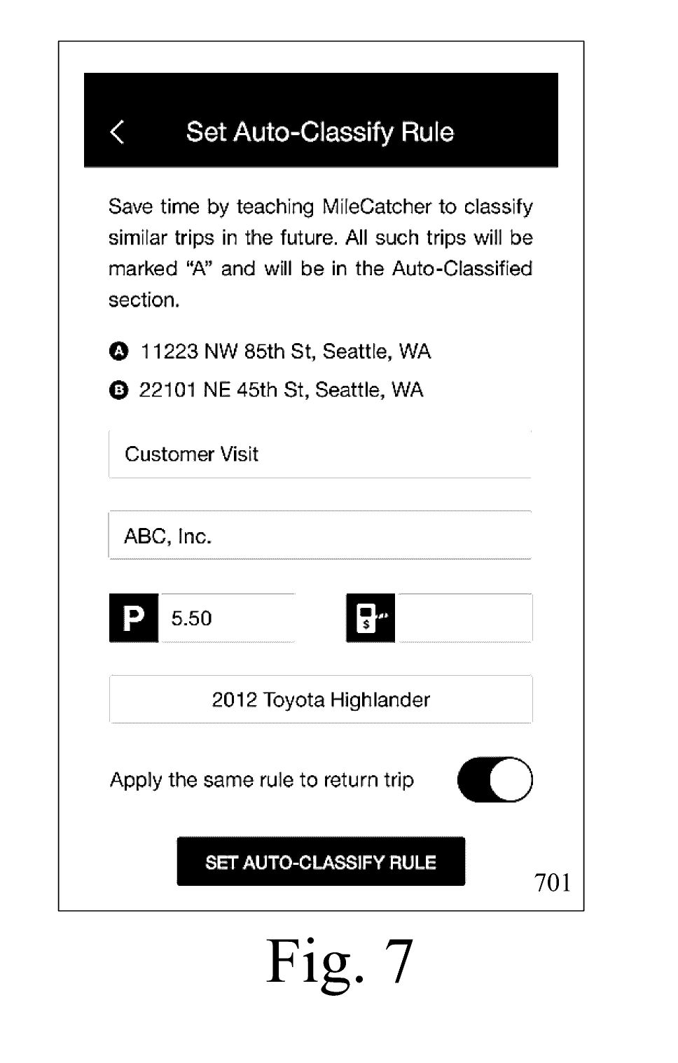

FIG. 7 illustrates the creation of a rule in the present invention using a GUI 701. The GUI 701 allows a user to enter starting and ending locations A & B, as well as labeling and defining the destination/end location with a label, name, and trip value or expense. The user can also elect to set the return trip to apply the same rule.

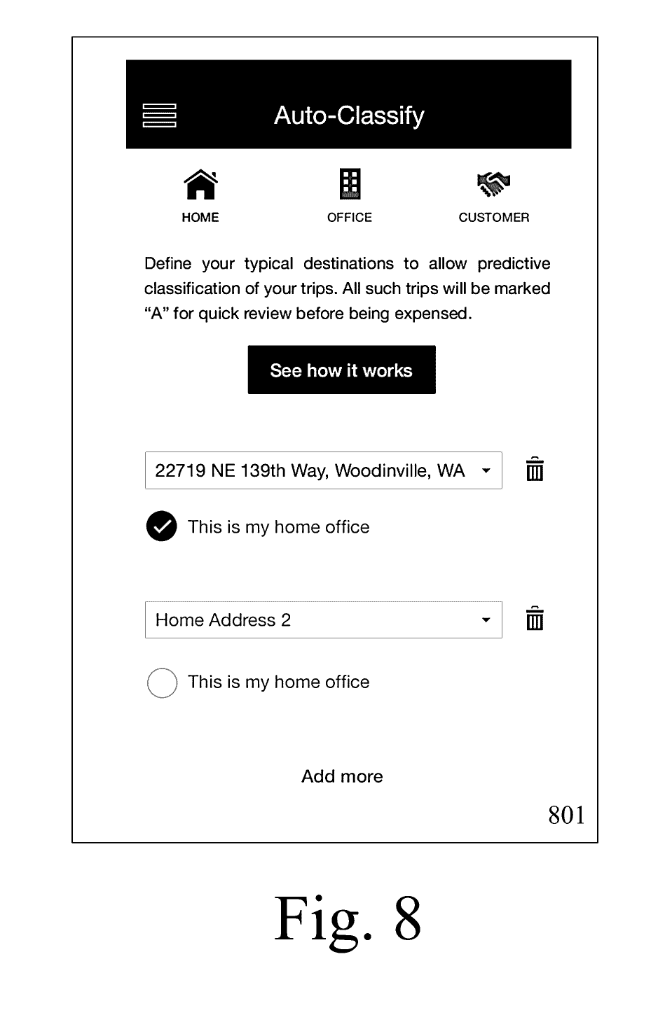

FIG. 8 illustrates the list of a GUI to enter typical destination locations such as home and workplaces or offices 801. Here, a user is defining their typical destinations to allow predictive classification of their trips. All such trips classified by this method are distinctly marked with an “A” for quick review before being expensed.

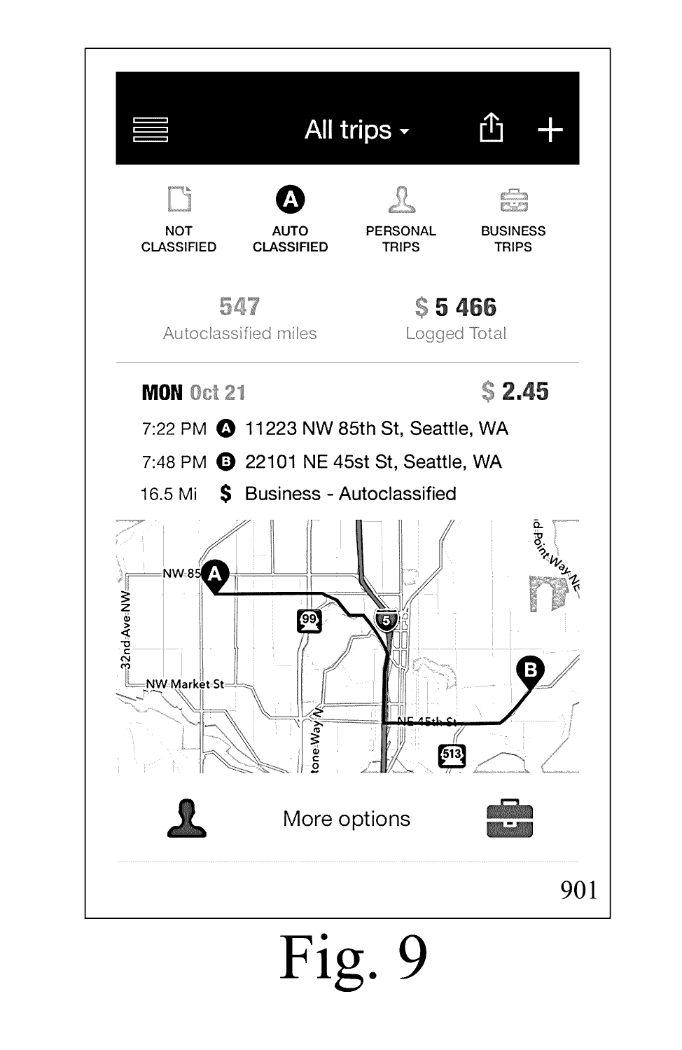

FIG. 9 illustrates the reporting and classification of a typical trip by the present invention 901. In this illustration the path of the trip is shown on a map with the starting and ending/destination points shown as A&B respectively. Above the map, the total miles and total expenses for all logged trips are shown as well as the trip summary showing the start and end times of the trip, classification, mileage, and individual expense amount of the most recent trip.

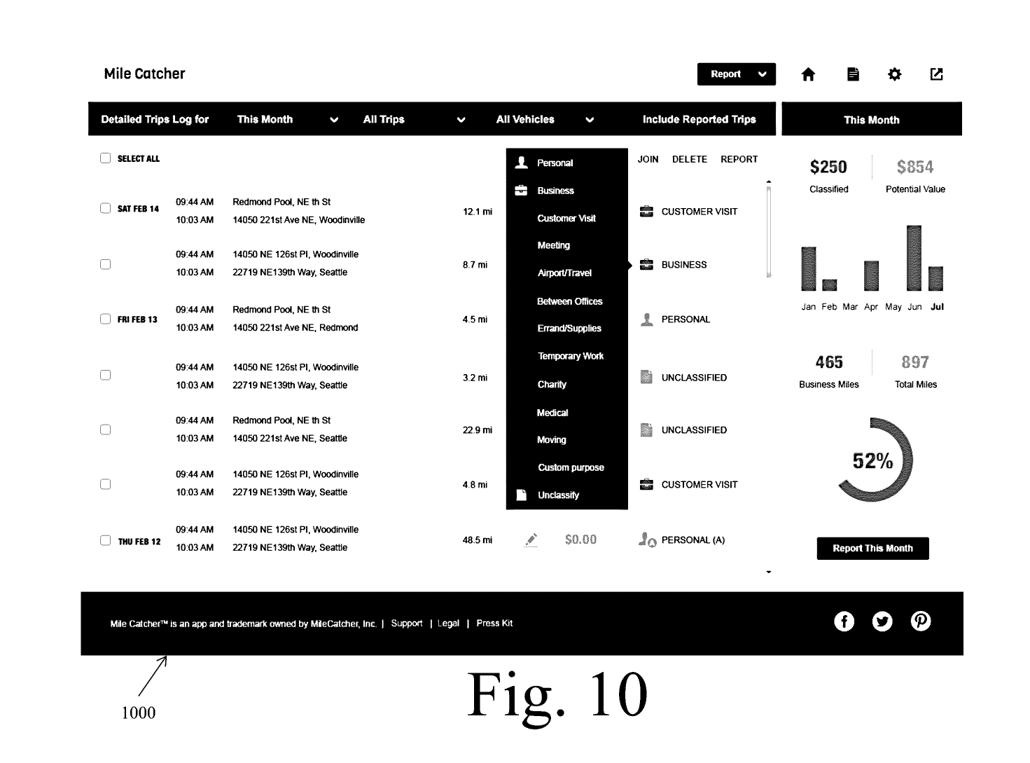

FIG. 10 illustrates a reporting feature shown on a GUI listing a plurality of trips that have been auto-classified by the present invention with additional calculated information 1000. This monthly report lists the trips selectable by day, trip type, vehicles, and other factors which are searchable and selectable for generating a targeting report. The right hand side of the report also includes a monthly breakdown of business miles and personal miles.

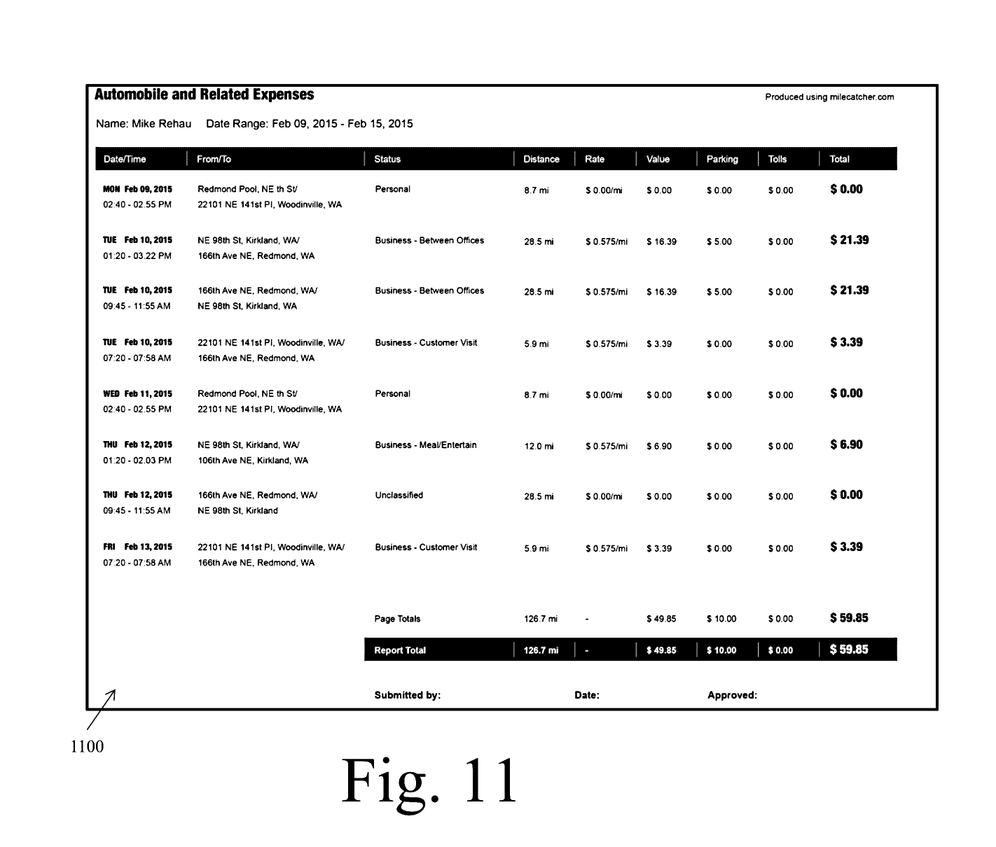

FIG. 11 is a GUI illustration of a typical automobile and related expense report calculated by the present invention 1100. The report lists trips for a singer user for a specific date range. Each trip is shown by date/time, from/to locations, its status or classification as personal or business, and a cost estimate based on distance, rate, value, parking, and tolls for determining a total individual trip expense and total expenses for the period and user selected.

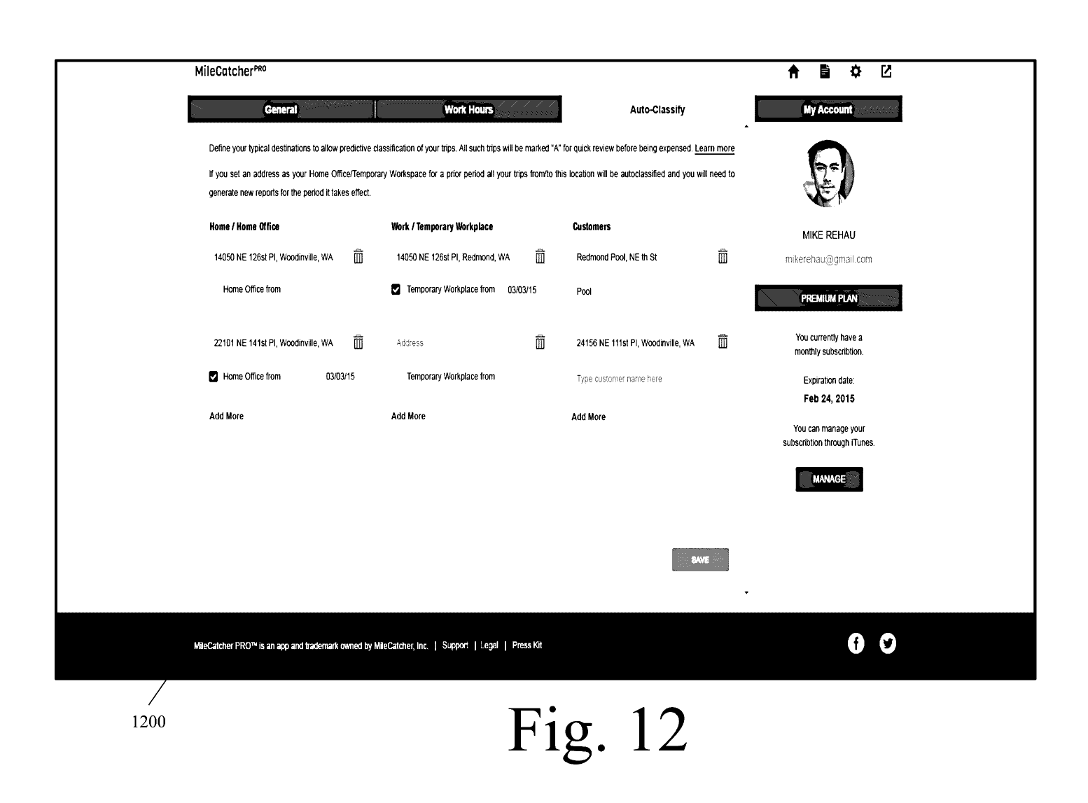

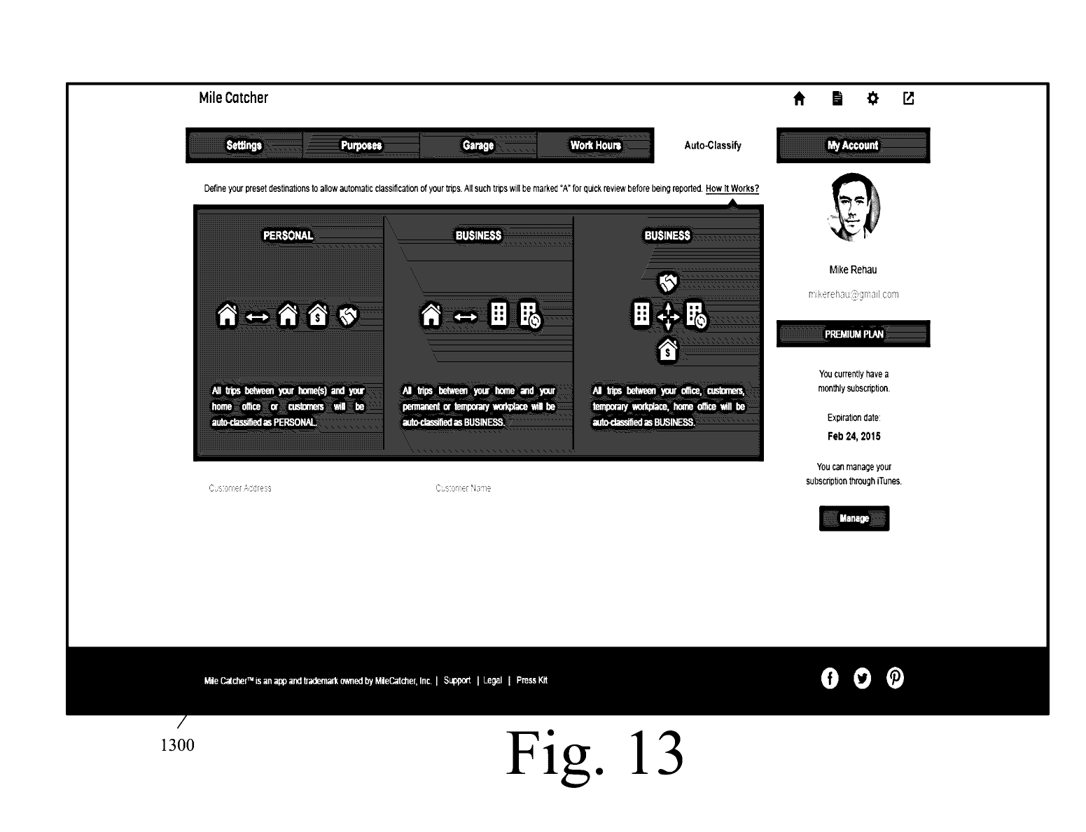

FIGS. 12-13 are GUI illustrations of a user account where a user can enter specific and custom information about their life to better help the method automatically classify their trips 1200. As before, a user can enter a plurality of business or home locations as well as setting rules for work hours and auto-classification 1300.

Now referring to FIGS. 14-17, the auto classification system method is illustrated. An auto-classify algorithm can eliminate the need for a large number of trips to be manually classified saving significant time keeping an accurate mileage log and providing a better analysis of fleet productivity while helping to estimate precise business insurance quotations for W2 employees and 1090 contractors.

Each trip from is reported by the present invention with the specific departure and arrival address locations a and b and a radius x as shown in FIG. 14. Any trip within a radius X of address location a is considered an arrival at destination A. Any trip within a radius X of address location b is considered a trip arriving at destination B as stored in the external database 1401 and a user trip classification database 1402.

Three patentable input features make up the method to Auto-Classify a future trip. First, a User can pre-classify specific addresses within categories Home, Office, Customers, etc. and have the method of the present invention auto-classify trips using A-B locations using the specific country tax rules. Secondly a Driver can manually classify a specific trip A-B in an application or portal after trip completion marking an Auto-Classify trip and deciding if the classification is also valid in a reversed direction. Any prior or just future repeated trip will be auto-classified the same way. Third, if A and B has been pre-classified by another user or by an external database of e.g. company and residential addresses then the algorithm of the present invention will auto-classify trips and improve the algorithm as users review and adjust auto-classified trips.

All three methodologies outlined can be used in combination to improve accuracy of Auto-Classify algorithm, but input source one will carry higher priority than input source two that will carry higher priority than input source three if available.

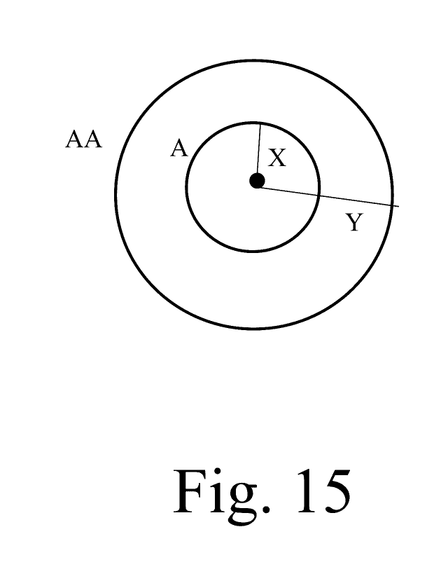

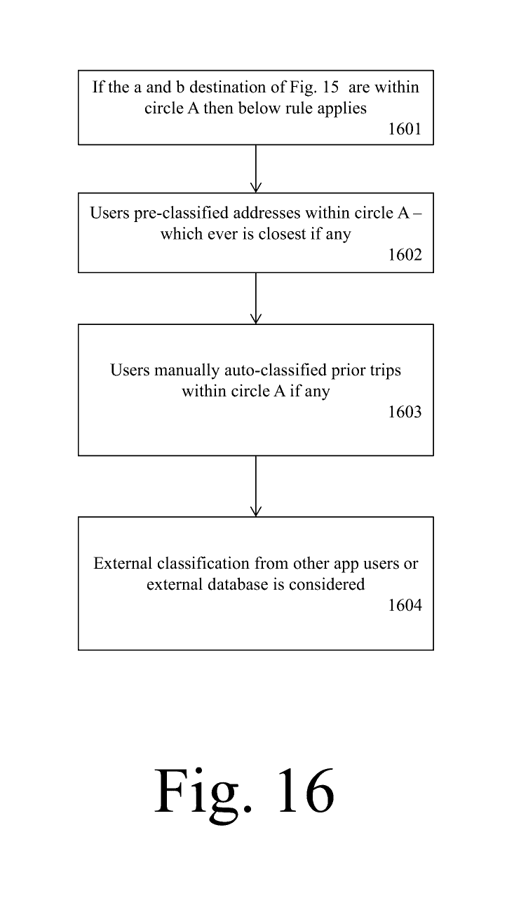

Now referring to FIG. 16, if the a and b destination of FIG. 15 are within circle A then the following rules apply 1601. First, Users pre-classified addresses within circle A—whichever is closest, if any 1602. Second, Users manually auto-classified prior trips within circle A, if any 1063. Third, external classification from other app users or external database is considered 1604.

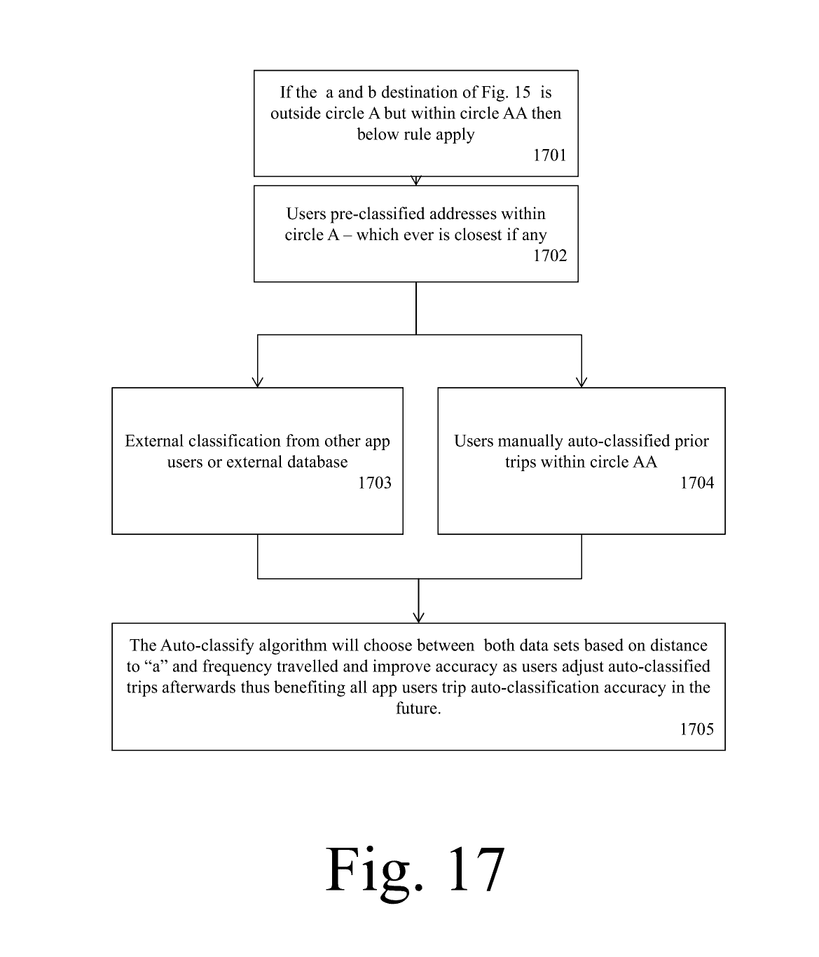

Now referring to FIG. 17, if the a and b destination of FIG. 15 is outside circle A but within circle AA then following rules apply 1701. First, Users pre-classified addresses within circle A—whichever is closest if any are applied 107. Next external classification from other app users or external database1703 and a User's manually auto-classified prior trips within circle AA are considered in the determination 1704. The Auto-classify algorithm will choose between both data sets based on distance to “a” and frequency travelled and improve accuracy as users adjust auto-classified trips afterwards thus benefiting all app users trip auto-classification accuracy in the future 1705.

In another embodiment, the present invention can be readily adapted to provide a pay for use case like car rental or car sharing where it would make sure it's the driver driving the car who has the account with the car rental or car sharing service.

In yet another embodiment, the present invention can be readily adapted to define driving behavior and usage (time of day, total distance, driving style, location) to help define actual driving risk for a UBI or pay per use insurance policy where it would make sure the insurance company bills for the distance driven by the insurance holder easily collected wireless without use of hardware dongle.

In still yet another embodiment, the present invention can be readily adapted to road usage tax where it would assign distance to driver disregard vehicle used easily collected wireless without use of hardware dongle.

In still yet another embodiment, the present invention can be readily adapted to electronic driving license renewal where it would assign a current driving score to driver disregard vehicle used easily collected wireless without use of hardware dongle.

In another embodiment, the present invention can be readily adapted to allow define if device owner was the driver or the passenger in a car involved in an accident or driving while under influence.

In still yet another embodiment, the present invention can be readily adapted to billboard or retail advertising effectiveness where it would measure AB tests to ensure that the time spent in front of specific destination, such as a billboard or display windows, and the direction of the user after the ad has been displayed to determine if it a viewer proceeded in the store as shopper or away as not interested.

In another embodiment, the present invention can be readily adapted to allow users to earn store credit or achieve bonus when arriving at or moving down store isle as desired.

In another embodiment, the present invention can be readily adapted to allow build incentive programs for good driving behavior tied to store or financial incentives.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

The present invention is set to run on a computing device. A computing device on which the present invention can run would be comprised of a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the invention. The present invention can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method for the automatic classification of trips using computer-readable medium capable of execution by a mobile device, the method comprising:
a sensor device;
the sensor device collecting current motion data before, during, and after a trip;
a software application running on the sensor device or data analysis in the cloud;
the software application storing one or more user profiles;
the software application comparing collected motion data to past motion data;
the software application comparing the collected motion data to specific user rules based on the starting location an destination;
determining based on historical and rules based comparisons whether the trip was personal or business; and
classifying the trip as either personal or business.

2. The method of claim 1, further comprising the steps of:
reporting each trip with the specific departure and arrival address locations a and b and an radius x;
any trip within radius X of a is considered an arrival at destination A; and
any trip within radius X is considered a trip arriving at destination B as stored in the external and user trip classification databases.

3. The method of claim 1, further comprising the steps of a first input source:
pre-classifying a specific addresses within categories Home, Office, Customers etc.; and
auto-classifying a trip using A-B locations using the specific country tax rules.

4. The method of claim 3, further comprising the steps of a second input source:
manually classifying a specific trip A-B in app or portal after trip completion;
marking Auto-Classify trip;
deciding if a trips classification is also valid in reversed direction; and
auto-classifying any prior or just future repeated trip the same way.

5. The method of claim 4, further comprising the steps of a third input source:
wherein if A and B has been pre-classified by another user or by an external database of e.g. company and residential addresses, auto-classifying trips and improving the algorithm as users review and adjust auto-classified trips.

6. The method of claim 5, wherein the input source one will carry higher priority than input source two that will carry higher priority than input source three if available.

7. The method of claim 5, wherein
if the a and b destination are within circle A then the following rules apply:
Users pre-classified addresses within circle A—whichever is closest, if any;
Users manually auto-classified prior trips within circle A, if any; and
external classification from other app users or external database is considered.

8. The method of claim 5, wherein
if the a and b destination of is outside circle A but within circle AA then following rules apply:
Users pre-classified addresses within circle A—whichever is closest, if any are applied;
external classification from other app users or external database and a User's manually auto-classified prior trips within circle AA are considered in the determination; and
the algorithm will choose between both data sets based on distance to “a” and frequency travelled and improve accuracy as users adjust auto-classified trips afterwards.

9. The method of claim 1, wherein the sensor device is a mobile electronic device.

10. The method of claim 9, wherein the mobile electronic device is a smartphone.

11. The method of claim 1, further comprising the step of:
determining if the user/person was the driver or the passenger during the trip.

12. The method of claim 1, wherein Trips which are less than a set amount of minutes apart get merged into one.

13. The method of claim 1, further comprising the steps of:
defining driving behavior and usage based on time of day, total distance, driving style, and location to help define actual driving risk for tax reporting purposes; and
calculating traveling expenses and an estimated tax deduction for driving activity based on the classified trip.

14. The method of claim 1, further comprising the steps of:
calculating the amount of driving distance for an identified driver;
assign the measured or calculated distance to the identified driver; and
calculating an individual trip expense.

15. The method of claim 14, further comprising the steps of
summarizing a selectable range of trips for an individual user; and
generating a report based on the selected range of trips for an individual user.
